(19) United States
(12) Patent Application Publication
(10) Pub. No.: US 2024/0368408 A1
(43) Pub. Date: Nov. 7, 2024

(54) BIOGENIC BLACK PIGMENT, METHOD FOR THE PRODUCTION THEREOF AND USE THEREOF

(71) Applicant: Suncoal Industries GmbH, Ludwigsfelde (DE)

(72) Inventors: Geertje Dautzenberg, Potsdam (DE); Tobias Wittmann, Berlin (DE); Günther Etzrodt, Stuttgart (DE); Meike Roth, Ludwigsfelde (DE)

(73) Assignee: Suncoal Industries GmbH, Ludwigsfelde (DE)

(21) Appl. No.: 18/289,381

(22) PCT Filed: May 5, 2022
(86) PCT No.: PCT/EP2022/062166

§ 371 Date: Nov. 3, 2023

(30) Foreign Application Priority Data
May 5, 2021 (EP) 21172354.9

(51) Int. Cl. C09C 1/56; C08K 3/04

(52) U.S. Cl. CPC C09C 1/56; C01P 2004/51; C01P 2006/12; C01P 2006/60; C01P 2006/88; C01P 2006/90; C08K 3/04

(57) ABSTRACT

A biogenic black pigment with a ¹⁴C content of more than 0.20 Bq/g carbon and less than 0.45 Bq/g carbon, a mass fraction of volatile constituents, as determined according to DIN 51720, relative to the dry mass of the pigment, of 20% by mass to 40% by mass, a mass fraction of carbon, as determined according to DIN 51732, relative to the dry mass of the pigment, of 60% by mass to 95% by mass, an ash content, relative to the dry mass of the pigment, of 0.5% by mass to 7% by mass, a mass fraction of polycyclic aromatic hydrocarbons (PAHs), relative to the dry mass of the pigment, of <10 ppm, a mass fraction of lead, mercury, cadmium and chrome of <100 ppm in total, relative to the dry mass of the pigment, an STSA surface area of 5 m²/g to 200 m²/g, and a d99 value of the Q₃ cumulative curve distribution of the particle size of ≤100 μm, a process for producing biogenic black pigment, a use of the biogenic black pigment for achromatic coloring and color shading of plastics, plastic parts, coating materials, printing inks, inks, paints, papers, cardboards, cartons, and mineral materials, and as a reinforcing filler for rubber-like, thermoplastic, liquid crystalline, and magnetorheological elastomers; as well as materials and articles that contain the biogenic black pigments.

### FIELD OF THE INVENTION

The present invention relates to a biogenic black pigment.

The present invention also relates to a process for the production of the biogenic black pigment.

Last but not least, the present invention relates to the use of the biogenic black pigment.

### STATE OF THE ART

Carbonaceous charred materials were used for cave drawings as early as the Stone Age. The technical requirements for such materials were low, a more or less black color shade was sufficient. As is known from Egyptian wall drawings, the Egyptians were already using coarse mortars to finely grind carbonaceous charred materials for the fabrication of colors/paints.

However, an exact reproducibility of the color shade and especially of the color strength was not possible in this way.

The production of soot or carbon blacks as a black pigment for inks and India inks goes back to the early advanced civilizations of mankind. At the time of the ancient advanced civilizations of the Chinese and Egyptians, the demand for small and minute soot particles was constantly increasing so that large quantities of ink and India inks could be produced from them. The soot required for this purpose was obtained by selective combustion of resins, vegetable oils or asphalt in special furnaces or shallow tubs.

In the Middle Ages, soot extraction was the business of soot burners, who burned heavily smoking resinous wood and the residue produced during the manufacture of pitch in their forest huts. The soot escaping with the smoke settled in the soot chamber of the fume hood, where it could be scraped off. Soot of the finest quality was the lamp soot which was burned in the “soot lamp” with the help of a thick cotton wick from oils, fats, tranes, pitch and tar oil under reduced air supply. This soot was needed to make leather dye, paints, printing ink, inks, and cambouis.

Instructions for the production of soot can be found in the Codex latinus Monacensis 4, a manuscript produced around 1470 in the Tegernsee monastery. In order to produce particularly fine soot for special applications, mainly tree resins were burned under limited air supply. Until the 16th century, this was the only known process for producing soot with the smallest particle sizes that would be comparable to carbon black. This process is still used today under the name of flame soot process. From the 19th century, soot was increasingly obtained from natural gas and coal tar.

The term “carbon black” became widespread in the 1870s, when products made from natural gas were sold under that name. In 1882, Godfrey Lowell Cabot founded the first production plant for industrial carbon black, which was operated using the channel black process to produce “channel black”. The main use of this carbon black was as a component of printing ink. Since natural gas was only available in insignificant quantities in Germany, intensive research was conducted for alternatives using domestic raw materials. Coal tar in significant quantities is a residual product in gas plants during the condensation of gas. In 1889, Otto Thalwitzer developed the so-called furnace process on the basis of tar oil from coal tar. Although “closed reactors” had been developed and the furnace processes yielded much higher yields, the oil-furnace process did not gain acceptance until 1943 due to the shortage of primary energy sources.

Mass production of carbon blacks began as a consequence of the expanding tire industry in the first half of the 20th century. In 1922, the oil-furnace process was patented, but it was not used until later.

In Germany, the Degussa gas black process by the name of “Gas-Black” and based on tar oils was developed in 1934.

Technically, the development of “Furnace carbon blacks” proceeded in four waves: A first generation of products differed mainly in the size of the primary particles and thus the specific surface area; in a second generation, the aggregation behavior, i.e., the “degree of intergrowth” of the primary particles or the “structure”, was varied.

The production of pigment carbon black for black varnishes was registered by Degussa in 1978 under the number DE 28 46 405. In the year 1981, Degussa registered the process for the production of furnace black under DE 3141 779. In 1987, the Cabot Corporation, Waltham, Mass., USA, registered a process for modifying the surface characteristics of carbon black under DE 3703077. In 1988, the Cabot Corporation, Waltham, Mass, USA filed a “process for the production of carbon black” with a wide aggregate size distribution.

All these technical processes have the disadvantage that the Carbon Black pigment or pigment carbon black is obtained from fossil raw materials. The required energy input is very high, as is the emission of carbon dioxide.

Another disadvantage is that the content of acidic surface oxides must be increased on the pigment carbon blacks by oxidative post-treatment in order to make them processable. Nitrogen dioxide, nitric acid or ozone serve as oxidizing agents.

Carbon powders are also offered on the market. These carbon powders consist of pyrolyzed oak wood, coconut shells or hemp materials, for example. These materials have a large particle size distribution and low color strength. In the colorations, e. g., in PVC-p, distinct pinholes due to large particles occur. Except for a powdered coconut charcoal, all these materials have only a more or less brown hue or are bluish or grayish like oak charcoal, graphite flakes, pine charcoal or vine charcoal (supplier: Werth-Metall, ArnstAdter Str. 21, 99096 Erfurt). As pigments, these materials are of no use.

The Chinese manufacturer Spec Chem Industry Inc. (Shilin Industrial Park, No. 10 Wanshou Road, Jiangbei New Area, Nanjing, PR. China) (www.specchemind.com) offers carbon black pigments produced from bamboo, wood, coconut shells, oak wood and “food-grade” vegetables by pyrolysis at 1,000° C. The particle sizes of the SpecKare®BCP pigment range from 2,500 nm to 5,000 nm (2.5 μm to 5 μm). The pigments are used in cleansing products for face and body, in dental care, mud packs, cakes, cookies and ice cream.

Commercially available, intensely coloring Carbon Black pigments have particle sizes between and 100 nm. SpecKare® BCP is very weak in color and not suitable for technical coloring of plastic materials.

In her master's thesis, “Biochar as a Substitute for Carbon Black in Lithographic Ink Production,” RIT Scholar Works, Rochester Institute of Technology, 2019 (https://scholarworks.rit.edu/theses), Vanessa Hulse investigates the production of black pigments for lithographic inks from papers, recycled wood pulp, and non-recyclable paperboard for boxes using hydrothermal carbonization (HTC). For the production of pigments, it is essential that inorganic components such as silicon dioxide, titanium dioxide and calcium oxide are separated from the starting products prior to carbonization in a complex process. Another disadvantage is that the pigments have a brown hue and are not suitable for the production of black and cool colors.

### Object of the Present Invention

The present invention was based on the object of producing a biogenic black pigment from regrowing materials, which has a deep black color, high color strength, good dispersibility, a low PAH value and a low heavy metal content. In addition, the biogenic black pigment should be outstandingly suitable for achromatic coloring and color shading of plastics, plastic parts, coating materials, printing inks, inks, paints, papers, cardboards, cartons, and mineral materials, and as a reinforcing filler for rubber-like, thermoplastic, liquid crystalline, and magnetorheological elastomers. In the following, “regrowing materials” will also be referred to as regrowing raw materials or biomass.

### Solution According to the Invention

Accordingly, the biogenic black pigment according to the invention was found according to the independent claim 1. Advantageous embodiments of the biogenic black pigment according to the invention are the subject matter of the dependent claims 2 to 6.

Furthermore, the process according to the invention for producing the biogenic black pigment according to the invention was found according to independent process claim 7. Advantageous embodiments of the process according to the invention are the subject matter of the dependent process claims 8 to 15.

Furthermore, the use of the biogenic black pigment according to the invention was found according to the independent use claim 16.

Last but not least, the materials and articles of the invention containing biogenic black pigments according to the invention were found according to the independent claim 17. The dependent claim 18 relates to particularly advantageous materials and articles according to the invention.

### Advantages of the Invention

In view of the prior art, it was surprising and not foreseeable for the person skilled in the art that the problem underlying the present invention could be solved with the aid of the biogenic black pigment according to the invention, the process for its production according to the invention, its use according to the invention and the materials and articles according to the invention.

It was particularly surprising that the biogenic black pigment according to the invention exhibited a deep black hue, high color strength, good dispersibility, a low PAH value and low heavy metal content. In addition, the biogenic black pigment was outstandingly suitable for achromatic coloring and color shading of plastics, plastic parts, coating materials, printing inks, inks, paints, papers, cardboards, cartons, and mineral materials, and as a reinforcing filler for rubber-like, thermoplastic, liquid crystalline, and magnetorheological elastomers.

Furthermore, the biogenic black pigment according to the invention was non-toxic due to its particularly low content of polycyclic aromatic hydrocarbons (PAHs) and its particularly low content of heavy metals, which was below the respective limit values.

Without wanting to be bound to any particular theory, the advantageous properties of the biogenic black pigment according to the invention and thus also of the process for its production according to the invention could be attributed to the fact that the black pigment was slightly polar because it had a carbon content <95% by mass and an oxygen content >5% by mass. This eliminated the need for the usual and well-known oxidative post-treatment with toxic gases such as nitrogen dioxide or ozone, which was a particularly noteworthy advantage.

Furthermore, the advantageous properties of the biogenic black pigment according to the invention and thus also of the process for its production according to the invention could be attributed to the fact that the black pigment was not obtained from the gas phase, but was obtained from a biogenic raw material by precipitation followed by pyrolysis.

The process according to the invention, which started from a special biogenic particulate carbon material as the starting product, delivered the desired advantageous end product in high yield and in an outstandingly reproducible manner. The special biogenic particulate carbon material allowed the pyrolysis to be carried out during the process according to the invention in a comparatively short time at comparatively low temperatures, which is why the process according to the invention was particularly energy-efficient compared to other pyrolysis processes. Furthermore, the special biogenic particulate carbon material allows the resulting biogenic black pigment to be excellently suited for achromatic coloring and color shading.

Another advantage was that the starting product of the process according to the invention was itself a value product that can be easily produced and also used in a variety of ways, so that it was always available in sufficient quantities. This made the process according to the invention and thus the biogenic black pigments according to the invention particularly economical.

Due to its particularly advantageous properties, the biogenic black pigment according to the invention could be put to use in numerous applications that were surprising in their diversity. Thus, the biogenic black pigment according to the invention was advantageously different from conventional carbon blacks and black pigments commercially available.

Therefore, materials and articles containing the biogenic black pigments of the invention also exhibited particular advantages in terms of application technology.

Further advantages will become apparent from the description.

### DETAILED DESCRIPTION OF THE INVENTION

The biogenic black pigment according to the invention has a ¹⁴C content of more than 0.20 Bq/g carbon, particularly preferably more than 0.23 Bq/g carbon, but less than 0.45 Bq/g carbon, preferably less than 0.40 Bq/g carbon. The determination of the ¹⁴C content is carried out by means of the radiocarbon method according to DIN EN 16640:2017-08.

The term “biogenic” in the sense of the present invention means that the black pigment according to the invention is obtainable from regrowing raw materials and is thus expressly not obtained from fossil raw materials.

The biogenic black pigment according to the invention has a proportion of volatile constituents, as determined according to DIN 51720, of 20% by mass to 40% by mass relative to the dry mass of the pigment. Preferably, this is at least 22.5% by mass. Preferably, this is at maximum 35% by mass, more preferably at maximum 30% by mass.

If DIN standards or other standards are specified without a date, the citation always refers to the most current version at the time of filing this application. In the case of DIN 51720, for example, this is DIN 51720:2001-03.

The dry mass is determined according to DIN 51718 here, the dry mass content of a sample being determined by: Proportion of dry mass=100%−total water content of the sample. The dry mass of the black pigment according to the invention is thus the anhydrous pigment.

The biogenic black pigment according to the invention preferably has a proportion of volatile constituents, as determined according to DIN EN 53552, of 20% by mass to 40% by mass relative to the dry mass of the pigment. Preferably, this is at least 25% by mass. Preferably, this is at maximum 35% by mass, more preferably at maximum 30% by mass. The volatile part of the black pigment according to the invention can thus be determined both according to DIN 51720 and DIN EN 53552.

The biogenic black pigment according to the invention preferably has a proportion of so-called fixed carbon of 60% by mass to 80% by mass, relative to the dry mass of the pigment. Preferably, this is at least 65% by mass, more preferably at least 65.5% by mass. Preferably, this is at maximum 75% by mass, further preferably at maximum 72.5% by mass. The proportion of fixed carbon relative to the dry mass of the pigment is calculated as follows: 100% by mass minus proportion of volatile constituents, as determined according to DIN EN 53552 and relative to the dry mass of the pigment, minus ash content of the pigment, as determined according to ASTM D1506-15 (550° C.), relative to the dry mass of the pigment.

The biogenic black pigment according to the invention has a mass fraction of carbon, as determined according to DIN 51732, of more than 60% by mass, preferably of more than 65% by mass, further preferably of more than 70% by mass, particularly preferably of more than 75% by mass, particularly preferably more than 77.5% by mass, relative to the dry mass of the pigment, respectively. The mass fraction of carbon relative to the dry mass is preferably lower than 95% by mass, more preferably lower than 94% by mass, even more preferably lower than 93% by mass, still more preferably lower than 90% by mass, particularly preferably lower than 87.5% by mass, moreover preferably lower than 85% by mass.

The biogenic black pigment according to the invention preferably has a mass fraction of oxygen relative to the ash-free dry mass of more than 5% by mass, preferably more than 7.5% by mass, further preferably more than 8% by mass, particularly preferably more than 9% by mass, particularly preferably more than 10% by mass, but preferably less than 20% by mass, preferably less than 17.5% by mass, particularly preferably less than 15% by mass, moreover preferably less than 12.5% by mass. The mass fraction of oxygen, relative to the ash-free dry mass, is calculated as follows: 100% by mass minus carbon content minus hydrogen content minus nitrogen content minus sulfur content, wherein carbon content, hydrogen content and nitrogen content respectively are determined according to DIN 51732, and sulfur content is determined according to DIN 51724-3. All values are relative to the ash-free dry mass, respectively. The ash content is determined according to ASTM D1506-15 (550° C.). The ash-free dry mass can be calculated from the difference of the dry mass as determined according to DIN 51718 and the ash content as determined according to ASTM D1506-15 (550° C.).

The biogenic black pigment according to the invention has an ash content as determined according to ASTM D1506-15 (550° C.) of more than 0.5% by mass, preferably more than 1% by mass and less than 7% by mass, preferably less than 6% by mass, preferably less than 5% by mass, particularly preferably less than 4% by mass, relative to the dry mass of the pigment, respectively.

The biogenic black pigment according to the invention preferably has been modified by means of at least one additive, preferably at least partially on its surface. Preferably, the biogenic black pigment according to the invention further has a mass fraction of at least one additive for modification, in particular for partial depolarization of the pigment surface, of 1.0% by mass to 10% by mass, relative to the dry mass of the pigment, respectively. This shall mean the mass fraction after the modification has been performed. It should be taken into consideration here that, depending on the additive used, elimination products such as alcohols may be formed during modification, which then do not contribute to the above-mentioned mass fraction. Preferably, the mass fraction is less than 8% by mass, further preferably less than 6% by mass. Preferably, the at least one additive for surface modification is selected from the group consisting of silanes, siloxanes, and alkylammonium salts of copolymers having acidic groups, and mixtures thereof. An example of a suitable additive based on alkylammonium salts of copolymers is BYK®-9076 from Atlanta. An example of a suitable additive based on organofunctional silanes is 3-aminopropyltrimethoxysilane (GENIOSIL® GF 96 from WACKER).

The biogenic black pigment according to the invention has a mass fraction of polycyclic aromatic hydrocarbons (PAHs), relative to the dry mass of the pigment, of less than 10 ppm. The fraction of polycyclic aromatics was determined by FDA Method 63 under 21 CFR Sec 178.3297:1994-07 in conjunction with MAS_PA036:2013-12 and MAS_PA017:2016-09. Preferably, the sum of the 22 PAHs according to FDA is less than 10 ppm, further preferably less than 8 ppm, particularly preferably less than 5 ppm. Preferably, the sum of the 7 GS-PAHs is less than 10 ppm, more preferably less than 5 ppm, particularly preferably less than 2 ppm. Preferably, the sum of the 18 GS-PAHs is less than 10 ppm, more preferably less than 8 ppm, particularly preferably less than ppm. Preferably, the mass fraction of benzo[a]pyrene, benzo[e]pyrene, benzo[a]anthracene, benzo[b]fluoranthene, benzo[j]fluoranthene, benzo[k]fluoranthene or dibenzo[a,h]anthracene is less than 2.0 ppm, further preferably less than 1.0 ppm, more preferably less than 0.5 ppm, in particular less than 0.25 ppm, in some cases less than 0.2 ppm, respectively.

The biogenic black pigment according to the invention has a mass fraction of lead, mercury, cadmium and chromium, relative to the dry mass of the pigment, of less than 100 ppm in total, preferably less than 50 ppm, particularly preferably less than 25 ppm, as determined according to DIN EN ISO 11885 and relative to the dry mass. The biogenic black pigment according to the invention preferably has a mass fraction of manganese, as determined according to DIN EN ISO 11885 and relative to the dry mass, of more than 10 ppm and less than 100 ppm.

The biogenic black pigment according to the invention has an STSA according to the ASTM standard D6556 of 5 m²/g to 200 m²/g, preferably 10 m²/g to 150 m²/g, preferably 15 m²/g to 150 m²/g, particularly preferably 20 m²/g to 120 m²/g and in particular 20 to 80 m²/g.

The biogenic black pigment according to the invention preferably has a BET according to ASTM standard D6556 that is preferably at least 10% higher than its STSA. Preferably, the BET is at least 25 m²/g, further preferably at least 30 m²/g, further preferably at least 50 m²/g, also preferably at least 100 m²/g, moreover preferably at least 150 m²/g, even more preferably at least 200 m²/g, further preferably at least 250 m²/g. The BET is at maximum 500 m²/g, preferably at maximum 400 m²/g, even more preferably at maximum 350 m²/g, in particular at maximum 300 m²/g.

Preferably, the BET is 5 m²/g, further preferably 10 m²/g, moreover preferably 20 m²/g particularly preferably 50 m²/g, in particular 100 m²/g, still preferably 150 m²/g, in some embodiments 200 m²/g higher than the STSA. However, the BET preferably is not more than 400 m²/g, particularly preferably not more than 300 m²/g above the STSA.

The true density of the biogenic black pigment is preferably less than 1.6 g/cm³, particularly preferably less than 1.5 g/cm³. The true density is determined by helium pycnometry, e. g. in a helium pycnometer (Pycnomatic ATC) of the company Porotec GmbH at a temperature of 20° C.

The particle size distribution of the biogenic black pigment is determined according to DIN ISO 13320:2020. Sample preparation is performed by dispersing the biogenic black pigment for 10 minutes with an Ultraturax to approximately 1% by mass in distilled water. In addition, sample preparation can be supplemented by the use of ultrasound with a defined energy input of preferably 6,000 Ws or 12,000 Ws. Treatment with ultrasound leads to deagglomeration. Regardless of whether the sample preparation is carried out with or without ultrasonic treatment, the measurement of the particle size distribution is carried out under ultrasound.

The D99 value of the Q₃ cumulative curve distribution of the particle size distribution without sample preparation with ultrasound of biogenic black pigment is lower than 100 μm. Preferably, it is lower than 50 μm, particularly preferably lower than 20 μm, particularly preferably lower than μm. in particular lower than 10 μm, in some embodiments lower than 5 μm. Preferably, it is higher than 0.5 μm, preferably higher than 1 μm, in particular higher than 2 μm. As mentioned hereinabove, the D99 value is determined according to DIN ISO 13320:2020.

The biogenic black pigment according to the invention preferably has a D50 value of the Q₃ cumulative curve distribution of the particle size distribution of 10 nm to 5000 nm. Preferably, it is higher than 100 nm, moreover preferably higher than 200 nm, particularly preferably higher than 500 nm, in particular higher than 750 nm. Preferably, the D50 value of the Q₃ cumulative curve distribution of the particle size distribution is lower than 4000 nm, further preferably lower than 3000 nm, in particular lower than 2000 nm, moreover preferably lower than 1000 nm. As mentioned hereinabove, the D50 value is determined according to DIN ISO 13320:2020.

Preferably, the D99 (or D50) of the Q₃ cumulative curve distribution of the particle size distribution that has been measured after sample preparation by ultrasound treatment with an energy input of 6000 Ws is at maximum 70%, further preferably at maximum 60% of the D99 (or D50) of the Q₃ cumulative curve distribution of the particle size distribution that has been measured after sample preparation without ultrasound treatment.

Preferably, the D99 (or D50) of the Q₃ cumulative curve distribution of the particle size distribution that has been measured after sample preparation by ultrasound treatment with an energy input of 6000 Ws is at least 10%, further preferably at least 20% of the D99 (or D50) of the Q₃ cumulative curve distribution of the particle size distribution that has been measured after sample preparation without ultrasound treatment.

After testing its color strength in a white mix with titanium dioxide according to DIN EN 13900-3, “Pigments and extenders—Methods of dispersion and assessment of dispersibility in plastics—Part 3: Determination of colouristic properties and ease of dispersion of black and colour pigments in polyethylene by two-roll milling” and a subsequent colorimetric measurement, the black pigment has a coloration equivalence value (FAE) smaller than or equal to 200, as compared with the reference product Printex 30 from Orion Engineered Carbon which has a mass fraction of volatile constituents at 950° C. of 0.7% by mass, a BET surface area of 80 m²/g and an oil absorption number OAN, measured with dibutylphthalate (DBP), of 105 ml/100 g.

The black pigment according to the invention is preferably used in a concentration of at least 1% and at maximum 5%, preferably at maximum 4%, further preferably at maximum 3%.

An exemplary biogenic black pigment according to the invention is characterized by the following colorimetric values, preferably when using 1 or 2%, more preferably 1%, in PVC-p or polypropylene, preferably polypropylene:
L*(D65): higher than 23, preferably higher than 24 and lower than 26, preferably lower than 25
a*(D65): higher than −0.4, preferably higher than −0.2, particularly preferably higher than −0.1 and lower than 0.2
b*(D65): higher than −0.5, preferably higher than −0.2, particularly preferably higher than −0.1 and lower than 0.2
dL*(D65): higher than 1.3 and lower than 1.4,
da*(D65): higher than 0.03 and lower than 1.0,
db*(D65): higher than −0.7 and lower than −0.5 and/or
dE*ab(D65): higher than 1.2 and lower than 1.5.

Color data (herein also referred to as colorimetric values) such as L*(D65), a*(D65), b*(D65), dL*(D65), da*(65), db*(D65) and dE*ab(D65) are determined in the sense of the present invention in particular by means of a spectrophotometer with CIE standard illuminant D65. The diffuse geometry (also spherical geometry, diffuse/8°, d/8°) with included specular (SPIN [specular included] or RSIN [reflectance specular included]) is used for this.

Preferably, the biogenic black pigment according to the invention has an L*(D65) value higher than 23, preferably higher than 24, and lower than 26, preferably lower than 25. Preferably, the biogenic black pigment according to the invention has an a*(D65) value higher than −0.4, preferably higher than −0.2, particularly preferably higher than −0.1 and lower than 0.2. Preferably, the biogenic black pigment according to the invention has a b*(D65) value higher than −0.5, preferably higher than −0.2, particularly preferably higher than −0.1 and lower than 0.2. Preferably, the biogenic black pigment according to the invention has a dL*(D65) value higher than 1.3 and lower than 1.4. Preferably, the biogenic black pigment according to the invention has a da*(D65) value higher than 0.03 and lower than 1.0. Preferably, the biogenic black pigment according to the invention has a db*(D65) value higher than −0.7 and lower than −0.5. Preferably, the biogenic black pigment according to the invention has a dE*ab(D65) value higher than 1.2 and lower than 1.5. The values preferably refer to a use of the black pigment in PVC-p or polypropylene, preferably polypropylene, respectively, preferably in an amount of 1 or 2%, particularly preferably 1%, respectively. Here, % shall preferably mean % by mass.

Particularly preferably, the black pigment is distinguished by the following colorimetric values, preferably when using 2% in PVC-p;
L*(D65): 25.62
a*(D65): −0.09
b*(D65): −0.31
dL*(D65): −1.34
da*(D65): 0.06
db*(D65): −0.84
dE*ab(D65): 1.38.

These colorimetric values compare advantageously with the colorimetric values of common and known carbon black pigments available on the market. Printex 30 from Orion Engineered Carbon, e. g., is suitable as a reference pigment.

The biogenic black pigment according to the invention is preferably produced by means of the process according to the invention.

The process according to the invention starts from at least one biogenic particulate carbon material with
a ¹⁴C content of more than 0.20 Bq/g carbon, particularly preferably more than 0.23 Bq/g carbon, but less than 0.45 Bq/g carbon, preferably less than 0.40 Bq/g carbon,
a carbon content relative to the ash-free dry substance between 60% by mass and 80% by mass, and
an STSA surface area of 5 m²/g to 200 m²/g, which is reacted to give the biogenic particulate black pigment.

Preferably, the biogenic, particulate carbon material employed is in itself no black pigment, in particular is not black.

Preferably the BET surface area of the biogenic particulate carbon material differs from its STSA surface area by at maximum 20%.

Preferably, a 15% suspension of the biogenic, particulate carbon material in distilled water has an electrical conductivity of <5 mS/cm.

As a measure of the proportion of graphitic carbon in the Raman spectrum, the biogenic particulate carbon material preferably has a D/G ratio of 0.2 to 9.0.

Preferably, the biogenic particulate carbon material has a D90 value of the Q₃ particle size distribution of <30 μm.

The brown biogenic particulate carbon material, its production and its use are described in detail in German patent application DE 10 2016 201 801 A1, paragraphs [0038] to [0083], and Examples 1 to 6, paragraphs [0147] to [0158].

Preferably, lignin-containing biomass, in particular lignin-containing biomass with a Klason lignin content greater than 80% by mass, relative to the dry mass, is used to produce the biogenic particulate carbon material (see DE 10 2016 201 801 A1, paragraph [0040]; Science Direct: Klason Lignin—an overview| ScienceDirect Topics, Apr. 28, 2021).

Herein, biomass is in principle defined as any biomass, wherein the term “biomass” herein includes so-called phytomass, i.e., biomass originating from plants, zoomass, i.e., biomass originating from animals, and microbial biomass, i.e., biomass originating from microorganisms including fungi, the biomass is dry biomass or fresh biomass, and it originates from dead or living organisms. The biomass particularly preferred herein and employed for the production of the black pigment is phytomass, preferably dead phytomass. Dead phytomass comprises, among other things, dead, rejected or detached plants and their parts. These include, for example, broken and torn leaves, cereal stalks, side shoots, twigs and branches, the fallen leaves, felled or pruned trees, as well as seeds and fruits and parts derived therefrom, but also sawdust, wood shavings/chips and other products derived from wood processing.

In a first process step the starting material described hereinabove (biogenic, particulate carbon material) is pyrolyzed, preferably at a temperature T_{pyrolysis} of 250° C. to 600° C., preferably from 350° C. to 500° C. Here it is advantageous to hold the temperature T_{pyrolysis} for between 1 minute and 180 minutes. During heating the starting product, when reaching 150° C., and during cooling of the resulting biogenic black pigment according to the invention down to at least 150° C., it is advantageous to adjust the oxygen content of the atmosphere to <10% by volume, preferably less than 5% by volume, particularly preferably less than 2.5% by volume, moreover preferably less than 2% by volume. Preferably, the oxygen content of the atmosphere is higher than 0.5% by volume.

In a preferred embodiment of the process according to the invention, pyrolysis is carried out in a drum furnace, a fluidized bed dryer, a fluidized bed reactor or a rotary kiln. Preferably, pyrolysis takes place in the fluidized bed, drum furnace or rotary kiln under an inert gas. Preferably, the inert gas consists of nitrogen and/or carbon dioxide, or of nitrogen and/or carbon dioxide with an oxygen content of <10% by volume, preferably less than 5% by volume, more preferably less than 2.5% by volume more preferably less than 2% by volume. Preferably, the oxygen content of the inert gas is greater than 0.5% by volume.

When using a rotary kiln, the inert gas in the rotary kiln is fed in countercurrent to the product stream.

Before pyrolysis, preferably the starting material (biogenic particulate carbon material) and/or after pyrolysis, preferably the resulting biogenic black pigment is subjected to fine grinding. In this process, the fine grinding is carried out so that the particle size of the biogenic black pigment is adjusted to the ranges of the D99 value and the D50 value of the Q₃ cumulative curve distribution indicated hereinabove. The preferred dry grinding process is gas jet grinding, preferably in a classifier mill, with air, nitrogen or superheated steam as grinding gas. Another preferred grinding process is grinding with grinding media in a ring chamber mill. The preferred wet grinding process is wet grinding, for example with grinding media in an agitator ball mill (attritor).

Preferably, glass beads or ceramic beads are used as grinding media, which preferably have a diameter of 2 mm to 10 mm.

According to the invention, it is advantageous to add at least one of the additives for surface modification described hereinabove during wet grinding.

Preferably, the suspension of the biogenic black pigment according to the invention resulting from wet milling has a pH between 5 and 11.

Formic acid can be added to the suspension until a pH value of less than 7 is reached. By the treatment with formic acid, the content of heavy metals can also be reduced even further.

In an embodiment of the process according to the invention that is preferred according to the invention, the biogenic black pigment according to the invention is filtered, and the filter cake is washed with water until the conductivity of the filtrate is ≤300 μS/cm.

In the further course of the process according to the invention, the filter cake is preferably dried at ≤80° C., and preferably the dried biogenic black pigment is subsequently deagglomerated in a mill.

In another preferred embodiment according to the invention, the suspension of the biogenic black pigment according to the invention is dried in a spray dryer.

The biogenic black pigment according to the invention is outstandingly suitable for the achromatic coloring and color shading of plastics, plastic parts, coating materials, printing inks, inks, paints, papers, cardboards, cartons, and mineral materials, and as a reinforcing filler for rubber-like, thermoplastic, liquid crystalline, and magnetorheological elastomers.

The materials and articles according to the invention, in particular the plastics, plastic granules, molded plastic parts, coating materials and coatings, printing inks and prints, inks and images and documents produced with these inks, paints and coatings, papers, cardboards, cartons, mineral materials and components, as well as components made of rubber-like, thermoplastic, liquid crystalline and magnetorheological elastomers, all of which contain at least one biogenic black pigment according to the invention, exhibit particularly advantageous application properties such as outstanding color strength, color fastness, color tone stability, light fastness and light resistance and, in their function as reinforcing fillers, an outstanding reinforcing effect already in low mass fractions.

Also according to the invention are materials which contain the biogenic black pigment according to the invention at a concentration of at least 1% and at maximum 5%, preferably at maximum 4%, further preferably at maximum 3%, and have the following colorimetric values:
L*(D65): higher than 23, preferably higher than 24 and lower than 26, preferably lower than 25
a*(D65): higher than −0.4, preferably higher than −0.2, particularly preferably higher than −0.1 and lower than 0.2
b*(D65): higher than −0.5, preferably higher than −0.2, particularly preferably higher than −0.1 and lower than 0.2
dL*(D65): higher than 1.3 and lower than 1.4,
da*(D65): higher than 0.03 and lower than 1.0,
db*(D65): higher than −0.7 and lower than −0.5 and/or
dE*ab(D65): higher than 1.2 and lower than 1.5.

Preferred materials which contain the biogenic black pigment of the invention comprise or consist of a matrix material selected from the following list: Polyester, polyethylene, polypropylene, polyester carbonates, polyamides, polyimides, polyesteramides, polyetherimides, polyurethanes, polyvinyl alcohols, polyvinyl acetates, polyvinyl chlorides, polymethacrylates, polystyrenes, styrene maleic acid anhydride, polycaprolactones, polybutylene terephthalates, polyepoxides; cellulose products such as cellulose acetate or cellulose nitrate, vulcanized fiber, polylactic acid, polyhydroxyalkanoates, chitin, casein, gelatin; formaldehyde resins, such as melamine-formaldehyde resin, urea-formaldehyde resin, melamine-phenol resins, phenol-formaldehyde resins; silicone polymer, natural rubber, styrene-butadiene copolymers, polybutadiene, polyisoprene, isobutylene-isoprene copolymers, ethylene-propylene-diene copolymers, acrylonitrile-butadiene-styrene copolymer, acrylonitrile-butadiene copolymers, chloroprene, fluorine rubber or acrylic rubber, and mixtures thereof.

Preferred use of the materials containing the biogenic black pigment according to the invention is the production of toys for children, car interior linings, plastic granulates for extrusion processes or food packaging.

Also according to the invention is an interlocking brick element which contains the biogenic black pigment of the invention at a concentration of at least 1% and at maximum 5%, preferably at maximum 4%, further preferably at maximum 3%, has at least 4 elevations and at least one indention, at least one indention being designed in such a way that it can accommodate at least one elevation of another interlocking brick element, thereby forming an interlocking connection between two interlocking brick elements, and which has the following colorimetric values:
L*(D65): higher than 23, preferably higher than 24 and lower than 26, preferably lower than 25
a*(D65): higher than −0.4, preferably higher than −0.2, particularly preferably higher than −0.1 and lower than 0.2
b*(D65): higher than −0.5, preferably higher than −0.2, particularly preferably higher than −0.1 and lower than 0.2
dL*(D65): higher than 1.3 and lower than 1.4,
da*(D65): higher than 0.03 and lower than 1.0,
db*(D65): higher than −0.7 and lower than −0.5 and/or
dE*ab(D65): higher than 1.2 and lower than 1.5. The invention will now be explained more specifically with reference to the following examples.

The examples are not intended to be limiting, but exemplify the nature and purpose of the invention. The person skilled in the art can readily give further examples on the basis of the technical teaching without having to become inventive himself.

### Production Example 1

### The Production of Two Finely Divided Biogenic Carbon Materials ES-A and ES-B as Starting Products for the Process According to the Invention

As described in the German patent application DE 10 2016 201 801 A1, the brown, finely divided, biogenic, particulate carbon materials are produced from kraft lignin by means of the following process steps:

(I) Lignin separation from black liquor analogous to the LignoBoost process:
Precipitation of the Kraft lignin from a Kraft black liquor from softwood by introducing CO₂.
Separation of the precipitated Kraft lignin by filtration.
Suspension of the separated Kraft lignin with water and sulfuric acid and
separation of the suspended Kraft lignin by filtration.
   (II) Production of the brown, finely divided, biogenic, particulate carbon materials by hydrothermal treatment:
Solution of the separated Kraft lignin in water and NaOH.
Hydrothermal treatment of the lignin solution.
Separation of the finely divided material from the liquid by filtration and washing.
Drying of the finely divided material and
grinding the finely divided material and obtaining the starting product.

The two resulting finely divided biogenic particulate carbon materials had the characteristics shown in Table 1.

TABLE 1
Characteristics of the starting products

| Material employed | ES-A | ES-B |
|---|---|---|
| BET (single point) [m²/g] | 45.7 | 34.0 |
| D90 [μm] | 8.4 | 18.2 |
| D50 [μm] | 2.4 | 5.3 |
| Volatile constituents, determined | 46.47 | 46.33 |
| according to DIN 51720 | | |
| STSA [m²/g] | 47.8 | 36.5 |

### Examples 1 to 4

### Production of the Biogenic Black Pigments PD-1 to PD-4 According to the Invention

For the production of the black pigments according to the invention, the starting products were pyrolyzed in a laboratory rotary kiln from the NaberTherm company with a glass inner tube having a length of 73 cm and a diameter of 10 cm. The pyrolysis conditions can be found in Table 2.

TABLE 2
Pyrolysis conditions

| Process | 1 | 2 | 3 | 4 |
|---|---|---|---|---|
| Material employed | ES-B | ES-B | ES-B | ES-B |
| Gas | N2 | N2 | N2 | N2 |
| Temperature [° C.] | 350 | 400 | 350 | 450 |
| Time [min] | 60 | 60 | 120 | 60 |
| Flow rate [l/h] | 250 | 200 | 200 | 200 |

The material compositions and physical properties of the obtained biogenic black pigments according to the invention can be found in Table 3.

TABLE 3
The material composition and the physical
properties of the black pigments

| Product | PD-1 | PD-2 | PD-3 | PD-4 |
|---|---|---|---|---|
| Process | 1 | 2 | 3 | 4 |
| STSA [m²/g] | 33.5 | 38.6 | 37.9 | 48.3 |
| D99 [μm] | 28.64 | 35.31 | 28.89 | 37.07 |
| D50 [μm] | 3.39 | 4.59 | 3.37 | 5.22 |
| CFIX [%] | 61.91 | 64.65 | 63.43 | 74.17 |
| Volatile constituents, | 33.43 | 30.6 | 31.79 | 20.89 |
| determined according | | | | |
| to DIN 51720 [%] | | | | |
| Ash [%] | 4.61 | 4.73 | 4.77 | 4.93 |
| PAK 22 [mg/kg] | <BG | 0.23 | | 4.65 |
| PAK 18 [mg/kg] | <BG | 0.23 | | 4.37 |
| Anthracene | <0.10 | <0.10 | | 0.46 |
| Benzo_a_anthracene | <0.10 | <0.10 | | 0.63 |
| Chrysene | <0.10 | <0.10 | | 0.41 |
| Fluoranthene | <0.10 | <0.10 | | 0.37 |
| Fluorene | <0.10 | 0.11 | | 0.27 |
| Naphthalene | <0.30 | <0.30 | | 0.04 |
| Phenanthrene | <0.20 | <0.20 | | 0.62 |
| Pyrene | <0.10 | 0.12 | | 0.48 |
| C - carbon [%] | 78.3 | 80.21 | | 85.38 |
| H - hydrogen [%] | 4.38 | 3.77 | | 3.52 |
| O - oxygen [%] | 16.48 | 15.27 | | 10.36 |
| N - nitrogen [%] | 0.26 | 0.24 | | 0.3 |
| S - sulfur [%] | 0.59 | 0.51 | | 0.44 |

BG = below detection limit

The PAH content was particularly low.

The black pigment PD-4 was treated with BYK® 90761 as a finish, incorporated into polypropylene (Daplen® 3007) and subjected to a comparative colorimetric measurement. The black pigments Printex® 30 and LampBlack (Color Index Pigment Black 6 (77266); particle size 90 to 120 nm) served as comparison pigments. A further comparison was made with respect to the starting material ES-B used. The results of the colorimetric measurements can be found in Table 4. In each case, 1% by mass of pigment/starting material was incorporated.

TABLE 4
Colorimetric values

| Designation | L*(D65) | a*(D65) | b*(D65) | dL*(D65) | da*(D65) | db*(D65) | dE*ab(D65) |
|---|---|---|---|---|---|---|---|
| Printex 30 | 25.62 | −0.15 | 0.03 | | | | |
| PD-4 | 24.28 | −0.09 | −0.31 | | | | |
| Lamp Black | 25.33 | −0.19 | −0.41 | −0.3 | −0.04 | −0.44 | 0.53 |
| ES-B | 33.11 | 18.79 | 36.80 | 3.62 | 18.94 | 36.77 | |

The biogenic black pigment PD-4 according to the invention could very easily be incorporated homogeneously into the polypropylene. The dyed polypropylene exhibited excellent colorimetric values which are in particular much better than those determined for the starting material ES-B.

### Example 5

### The Production of the Biogenic Black Pigment 5 According to the Invention

A porcelain crucible with a volume of 100 ml was filled to the brim with 15.38 g of the brown finely divided particulate biogenic carbon material ES-A and packed airtight with aluminum foil. The crucible was then annealed in a muffle kiln at 500° C. for 30 minutes; after this time the smoke development was finished. After cooling, the crucible was unpacked. The yield of the biogenic black pigment of the invention was 9.54 g, which corresponds to a yield after carbonization of 62.03%.

The black pigment was ground for 48 hours in a 1.5 l ball mill with 180 g water, 4.5 g BYK® 9076 and 500 g porcelain balls of 10 mm diameter. Then, the pigment suspension was separated from the porcelain balls via a sieve, filtered off in a Buchner funnel with vacuum via a special filter paper (Macherey-Nagel company, MN 85/70), dried at 60° C. in a drying cabinet and then ground in an impact grinding mill for 4 minutes.

The properties in terms of application technology of the biogenic black pigment of Example 5 according to the invention were excellent.

### Example 6

The production of the biogenic black pigment 6 according to the invention 250 g of the finely divided, particulate, biogenic carbon material ES-B was carbonized in a NaberTherm laboratory rotary kiln with a glass inner tube having a length of 73 cm and a diameter of 10 cm. The material was heated under a carbon dioxide atmosphere from 20° C. to 200° C. in 10 min and then heated to 480° C. in another 2 hours. In the process, 200 l of carbon dioxide per hour were passed through the glass inner tube. The duration of carbonization at 480° C. was one hour; then the material was cooled down to room temperature. The yield of the biogenic black pigment of the invention was 155 g; this corresponds to a yield after carbonization of 62%. The black pigment obtained does not tend to self-ignite in air.

### Example 7

### The Production of the Biogenic Black Pigment 7 According to the Invention

The black pigment of Example 6 was ground in screw-top jars with a volume of 250 ml, an inner diameter of 62 mm and an inner height of 75 mm. 150 g of glass beads with a diameter of 2.8 to 3.4 mm, 90 ml of water, and 10.0 g of black pigment 6 were filled into one screw cap jar each, respectively. 0.5 g Byk®9076 was added as an additive. Four of these filled screw cap jars were placed in a holder and grinding was performed in a color dispenser from the company Olbrich Know-How twice for 10 minutes each. Then, the pigment suspension was separated from the glass beads via a sieve, filtered off in a Buchner funnel with vacuum via a special filter paper (Macherey-Nagel company, MN 85/70), dried at 60° C. in a drying cabinet and then ground in an impact grinding mill for 4 minutes. The resulting biogenic black pigment 7 according to the invention also exhibited excellent properties in terms of application technology.

### Example 8

### The Production of the Biogenic Black Pigment 8 According to the Invention

The black pigment of Example 6 was ground in screw-top jars with a volume of 250 ml, an inner diameter of 62 mm and an inner height of 75 mm. 150 g of glass beads with a diameter of 2.8 to 3.4 mm, 90 ml of water, and 10.0 g of black pigment 6 were filled into one screw cap jar each, respectively. 0.5 g Geniosil GF 96 was added as an additive. Four of these filled screw cap jars were placed in a holder and grinding was performed in a color dispenser from the company Olbrich Know-How twice for 10 minutes each. The pigment suspension was then separated from the glass beads via a sieve, and the glass beads were cleaned of any black pigment still adhering with water. The pH of the pigment suspension was 9.4. Then, the pigment suspension was filtered off in a Buchner funnel with vacuum via a special filter paper (Macherey-Nagel company, MN 85/70), dried at 80° C. in a drying cabinet and then ground in an impact grinding mill for 4 minutes. This biogenic black pigment 8 according to the invention also exhibited excellent properties in terms of application technology.

### Example 9

### The Production of the Biogenic Black Pigment 9 According to the Invention

The black pigment of Example 6 was ground in screw-top jars with a volume of 250 ml, an inner diameter of 62 mm and an inner height of 75 mm. 150 g of glass beads with a diameter of 2.8 to 3.4 mm, 90 ml of water, and 10.0 g of black pigment 6 were filled into one screw cap jar each, respectively. 0.5 g Geniosil GF 96 was added as an additive. Four of these filled screw cap jars were placed in a holder and grinding was performed in a color dispenser from the company Olbrich Know-How twice for 10 minutes each. The pigment suspension was then separated from the glass beads via a sieve; the glass beads were cleaned of any black pigment still adhering with water. The pH of the pigment suspension was 9.9.

One fraction of the pigment suspension was further processed in Example 10. The remaining fraction was further processed as follows:

The pigment suspension was filtered off subsequently in a Buchner funnel with vacuum via a special filter paper (Macherey-Nagel company, MN 85/70), dried at 80° C. in a drying cabinet and then ground in an impact grinding mill for 4 minutes.

The analytically determined heavy metal contents are listed in Table 5. The analysis was performed in accordance with DIN EN ISO 11885, 2009-09 edition.

### Example 10

### The Production of the Biogenic Black Pigment 10 According to the Invention

In order to improve the properties in terms of application technology and reduce the heavy metal content, the pigment suspension from Example 9 was first adjusted to a pH of <6 with formic acid.

The resulting pigment suspension was then filtered off in a Buchner funnel with vacuum via a special filter paper (Macherey-Nagel company, MN 85/70). The pigment filter cake was washed in order to reduce the conductivity and thus the salinity of the black pigment 10 to a conductivity<300 μS/cm of the wash water. The obtained black pigment 10 was dried at 80° C. in a drying cabinet and ground in an impact grinding mill for 4 minutes. The analytically determined heavy metal contents are listed in Table 5. The analysis was performed in accordance with DIN EN ISO 11885, 2009-09 edition.

TABLE 5
Determination of the heavy metal content of
black pigments 9 and 10 according to DIN EN
ISO 11885, edition 2009-09, in mg/kg (ppm)

| | Black pigment | Black pigment |
|---|---|---|
| Heavy metal | according to Example 9 | according to Example 10 |
| Arsenic | <1 | <2 |
| Lead | 3.67 | 0.91 |
| Cadmium | 0.43 | <0.2 |
| Chrome, total | 13.8 | 4.8 |
| Copper | 138 | 22.6 |
| Nickel | 9.99 | 2.17 |
| Mercury | 5.88 | <0.1 |
| Boron | 13.7 | 25.0 |
| Barium | 33.3 | 9.2 |
| Cobalt | <0.1 | 0.47 |
| Molybdenum | 7.23 | 0.28 |
| Manganese | 40.5 | 35.2 |
| Antimony | 1.71 | 0.16 |
| Selenium | 6.84 | 0.03 |

By treating the black pigment 9 with formic acid according to Example 10, a substantial reduction in the heavy metal content was achieved.

### Example 11

### The Determination of Colorimetric Properties

Among the essential properties of pigments are their colorimetric properties such as color hue and color strength. These properties can only be determined in colorations in polymeric materials and in comparison to a reference pigment. The black pigments according to the invention of Examples 1 to 10 were tested in PVC-p, produced analogously to DIN EN 14469-1 and DIN EN 14469-2, or in polyethylene. The colorations were carried out according to DIN EN 13900-2 “Pigments and extenders—Methods of dispersion and assessment of dispersibility in plastics—Part 2: Determination of colouristic properties and ease of dispersion in plasticized polyvinyl chloride (PVC-p) forming masses”, and DIN EN 13900-3, “Pigments and extenders—Methods of dispersion and assessment of dispersibility in plastics—Part 3: Determination of colouristic properties and ease of dispersion of black and colour pigments in polyethylene by two-roll milling”. Printex® 30 from Orion Engineered Carbon was used as the comparison pigment. The colorimetric data were measured with the Minolta CM-5 colorimeter. The dosage of the pigments was 2% by mass in each case.

The biogenic black pigments of Examples 1 to 10 according to the invention exhibited excellent color shades and color strengths compared with conventional black pigments.

1. A biogenic black pigment with:
a ¹⁴C content of more than 0.20 Bq/g carbon and less than 0.45 Bq/g carbon,
a mass fraction of volatile constituents, as determined according to DIN 51720, relative to the dry mass of the pigment, of 20% by mass to 40% by mass,
a mass fraction of carbon, as determined according to DIN 51732, relative to the dry mass of the pigment, of 60% by mass to 95% by mass,
an ash content, relative to the dry mass of the pigment, of 0.5% by mass to 7% by mass,
a mass fraction of polycyclic aromatic hydrocarbons (PAHs), relative to the dry mass of the pigment, of <10 ppm,
a mass fraction of lead, mercury, cadmium and chrome, relative to the dry mass of the pigment, of <100 ppm in total,
a statistical thickness surface area (STSA) of 5 m²/g to 200 m²/g, and
a d99 value of the Q₃ cumulative curve distribution of the particle size of ≤100 μm.

2. The biogenic black pigment according to claim 1, wherein the biogenic black pigment is modified by means of at least one additive, optionally at least partially on its surface, optionally in such a way that the biogenic black pigment has a mass fraction of the at least one additive from 1.0% by mass to 10% by mass, relative to the dry mass.

3. The biogenic black pigment of claim 2, wherein the at least one additive for surface modification is selected from the group consisting of: silanes, siloxanes, and alkylammonium salts of copolymers having acidic groups, and mixtures thereof.

4. The biogenic black pigment according to claim 1, having a D50 value of the Q₃ cumulative curve distribution of particle size from 10 nm to 1000 nm.

5. The biogenic black pigment according to claim 1, wherein after testing its color strength in a white mix with titanium dioxide according to DIN EN 13900-3, “Pigments and extenders—Methods of dispersion and assessment of dispersibility in plastics—Part 3: Determination of colouristic properties and ease of dispersion of black and colour pigments in polyethylene by two-roll milling” and a subsequent colorimetric measurement, the black pigment has a coloration equivalence value (FAE) smaller than or equal to 200, as compared with the reference product Printex 30 from Orion Engineered Carbon which has a mass fraction of volatile constituents at 950° C. of 0.7% by mass, a BET surface area of 80 m²/g and an oil absorption number OAN, measured with dibutylphthalate (DBP), of 105 ml/100 g.

6. The biogenic black pigment according to claim 1, having the following colorimetric values, optionally after incorporation into a polypropylene in an amount of 1% by mass:
L*(D65): higher than 23, and lower than 26,
a*(D65): higher than −0.4, and lower than 0.2,
b*(D65): higher than −0.5, and lower than 0.2,
dL*(D65): higher than 1.3 and lower than 1.4,
da*(D65): higher than 0.03 and lower than 1.0,
db*(D65): higher than −0.7 and lower than −0.5 and/or
dE*ab(D65): higher than 1.2 and lower than 1.5.

7. A process for producing a biogenic black pigment according to claim 1, comprising starting with a product that is at least one biogenic particulate carbon material with:
a ¹⁴C content of more than 0.20 Bq/g carbon and less than 0.45 Bq/g carbon,
a carbon content relative to the ash-free dry substance between 60% by mass and 80% by mass, and
a statistical thickness surface area (STSA) of 5 m²/g to 200 m²/g.

8. The process according to claim 7, wherein the BET surface area of the biogenic particulate carbon material differs from its STSA by at maximum 20%.

9. The process according to claim 7, comprising conducting pyrolysis of the biogenic particulate carbon material at a temperature T_{pyrolysis} of 250° C. to 600° C.

10. The process of claim 9, comprising maintaining T_{pyrolysis} between 1 minute and 180 minutes, wherein during heating of the biogenic particulate carbon material, when reaching at least 150° C., and during cooling of the resulting biogenic black pigment down to at least 150° C., the oxygen content of the atmosphere is adjusted to <10% by volume.

11. The process according to claim 19, wherein the pyrolysis is carried out in a drum furnace, a fluidized bed dryer or a rotary kiln under inert gas.

12. The process according to claim 11, wherein the inert gas consists of nitrogen and/or carbon dioxide, or of nitrogen and/or carbon dioxide with an oxygen content of <10% by volume.

13. The process according to claim 9, wherein the biogenic black pigment resulting after pyrolysis is subjected to fine grinding.

14. The process according to claim 9, wherein at least one additive for surface modification is added after the pyrolysis.

15. The process of claim 14, wherein the at least one additive is selected from the group consisting of: silanes, siloxanes, and alkylammonium salts of copolymers having acidic groups, and mixtures thereof.

16. A method for achromatic coloring and chromatic shading comprising: mixing the biogenic black pigment according to claim 1 with one or more of: plastics, plastic parts, coating materials, printing inks, inks, paints, papers, cardboards, cartons, and mineral materials.

17. A material or article containing the at least one biogenic black pigment according to claim 1.

18. The materials or article according to claim 17 being selected from the group consisting of: plastics, plastic granules, molded plastic parts, coating materials and coatings, printing inks and prints, inks and images and documents produced with these inks, paints and coatings, papers, cardboards, cartons, mineral materials and components, as well as components made of rubber-like, thermoplastic, liquid crystalline and magnetorheological elastomers.

19. A method for reinforcing a material comprising: mixing the biogenic black pigment according to claim 1 as a filler with a rubber-like, thermoplastic, liquid crystalline, and magnetorheological elastomer.
